(19) United States
(12) Patent Application Publication
(10) Pub. No.: US 2019/0322412 A1
(43) Pub. Date: Oct. 24, 2019

(54) CONVERTIBLE RETAIL READY PACKAGE

(71) Applicant: WestRock Shared Services, LLC, Atlanta, GA (US)

(72) Inventors: David G. COUTURE, Suwanee, GA (US); Nicholas J. MATUELLA, Omaha, NE (US)

(21) Appl. No.: 15/959,519

(22) Filed: Apr. 23, 2018

(51) Int. Cl. B65D 5/54; B65D 5/02; B65D 5/42; B31B 50/26; B31B 50/62; B31B 50/72; B31B 50/25; B31B 50/74

(52) U.S. Cl. CPC B65D 5/5445; B65D 5/02; B65D 5/4266; B31B 50/74; B31B 50/624; B31B 50/722; B31B 50/25; B31B 50/26

(57) ABSTRACT

A retail ready package includes a plurality of panels extending at least partially around an interior space. Pairs of opposed flaps connect to opposed edges of the panels. On a first side of the interior space, respective pairs of the flaps overlap to form four side joints. At least one of the side joints includes adhesive joining the respective flaps, and at least one of the side joints is free of adhesive joining the respective flaps to facilitate conversion of the retail ready package for retail use.

### REFERENCE TO RELATED APPLICATION

This application claims the benefit of priority under 35 U.S.C. § 119(e) of U.S. provisional application Ser. No. 62/500,680 filed on May 3, 2017, which is hereby incorporated by reference in its entirety.

### BACKGROUND OF THE INVENTION

### 1. Field of the Invention

The present disclosure relates to retail ready packages (RRPs), and more particularly to convertible wrap RRP cases.

### 2. Description of Related Art

Conventionally, retail products are placed in cases at a production facility. Then, at a secondary location, the cases of product are packed out into retail ready packages (RRPs) sometimes referred to as shelf-ready packaging, which are then shipped for retail sale. At the retail location, the RRPs are converted, e.g., by opening a portion of the package, to display the product and make it accessible to customers. This conventional use of RRPs adds extra handling and waste between production and retail, but facilitates the ability of retailers and customers to handle the product.

The conventional techniques have been considered satisfactory for their intended purpose. However, there is an ever present need for improved RRPs. This disclosure provides a solution for this problem.

### SUMMARY OF THE INVENTION

A blank for forming a retail ready package (RRP) includes a plurality of panels connected together at fold lines configured for extending at least partially around an interior space. The plurality of panels includes a front panel, a top panel, a back panel and a bottom panel. A pair of opposed back flaps is foldably connected to opposed edges of the back panel. A pair of opposed bottom flaps is foldably connected to opposed edges of the bottom panel. A pair of opposed front flaps is foldably connected to opposed edges of the front panel. A pair of opposed top flaps is foldably connected to opposed edges of the top panel. A first one of the back flaps is configured to overlap with a first one of the top flaps to form a first side joint. The first one of the top flaps is configured to overlap with a first one of the front flaps to form a second side joint. The first one of the front flaps is configured to overlap with a first one of the bottom flaps to form a third side joint. The first one of the bottom flaps is configured to overlap with the first one of the back flaps to form a fourth side joint. At least one of the side joints includes adhesive joining the respective flaps, and at least one of the side joints is free of adhesive joining the respective flaps to facilitate conversion of the retail ready package for retail use.

A tear line can be defined across the front panel for tearing the front panel to convert the retail ready package. A handle tear line can be included in the front panel, connecting with the tear line defined across the front panel for gripping the front panel to convert the retail ready package. The tear line can extend obliquely across each of the front flaps.

A back portion of each of the top flaps can be beveled, a top portion of each of the back flaps can be beveled, and/or a front portion of each of the bottom flaps can be beveled. The plurality of panels can include a corrugated paper board material.

In embodiments, the front panel is connected to the top panel at a fold line, wherein the back panel is connected to the top panel at a fold line, and wherein the bottom panel is connected to the back panel at a fold line, wherein a tear line extends along an edge where the top panel and back panel meet. An adhesive tab can extend form an edge of the front panel opposite the top panel, wherein the adhesive tab is configured to be adhered to the bottom panel to join the front panel to the bottom panel. A tear line can be defined across the front panel for tearing the front panel to convert the retail ready package, wherein a handle tear line is included in the front panel, connecting with the tear line defined across the front panel for gripping the front panel to convert the retail ready package, and wherein an plurality of fold lines are defined in the front panel for facilitating activation of the handle tear line.

In embodiments, the top panel is connected to the front panel at a fold line, the bottom panel is connected to the front panel at a fold line, and the back panel is connected to the bottom panel at a fold line. An adhesive tab can extend from an edge of the top panel opposite the front panel, wherein the adhesive tab is configured to be adhered to the back panel to join the top panel to the back panel. The adhesive tab can connect to the top panel along a tear line for facilitating conversion of the retail ready package for retail use.

A retail ready package includes a plurality of panels as described above extending at least partially around an interior space. Pairs of opposed flaps connect to opposed edges of the panels as described above. On a first side of the interior space, a first one of the back flaps overlaps with a first one of the top flaps to form a first side joint, the first one of the top flaps overlaps with a first one of the front flaps to form a second side joint, the first one of the front flaps overlaps with a first one of the bottom flaps to form a third side joint, and the first one of the bottom flaps overlaps with the first one of the back flaps to form a fourth side joint. At least one of the side joints includes adhesive joining the respective flaps, and at least one of the side joints is free of adhesive joining the respective flaps to facilitate conversion of the retail ready package for retail use.

On a second side of the interior space opposite the first side, a second one of the back flaps can overlap with a second one of the top flaps to form a fifth side joint, the second one of the top flaps can overlap with a second one of the front flaps to form a sixth side joint, the second one of the front flaps can overlap with a second one of the bottom flaps to form a seventh side joint, and the second one of the bottom flaps can overlap with the second one of the back flaps to form an eighth side joint. At least one of the fifth, sixth, seventh, and/or eighth side joints can include adhesive joining the respective flaps, and at least one of the fifth, sixth, seventh and/or eighth side joints can be free of adhesive joining the respective flaps to facilitate conversion of the retail ready package for retail use. In embodiments, the first side joint and the fifth side joint are free of adhesive, and wherein the second, third, fourth, sixth, seventh, and eighth side joints each include adhesive.

A method of assembling a retail ready package (RRP) includes forming a plurality of panels to wrap at least partially around an interior space, wherein the panels include a front panel connected to a top panel, a back panel connected to the top panel, and a bottom panel connected to the back panel and to the front panel, with a pair of opposed back flaps foldably connected to opposed edges of the back panel, a pair of opposed bottom flaps foldably connected to opposed edges of the bottom panel, a pair of opposed front flaps foldably connected to opposed edges of the front panel, and a pair of opposed top flaps foldably connected to opposed edges of the top panel. The method includes overlapping a first one of the back flaps with a first one of the top flaps to form a first side joint on a first side of the interior space, overlapping the first one of the top flaps with a first one of the front flaps to form a second side joint on the first side of the interior space, overlapping the first one of the front flaps with a first one of the bottom flaps to form a third side joint on the first side of the interior space, and overlapping the first one of the bottom flaps overlaps with the first one of the back flaps to form a fourth side joint on the first side of the interior space. The method includes adhering respective flaps of at least one of the side joints, and leaving at least one of the side joints free of adhesive joining the respective flaps to facilitate conversion of the retail ready package for retail use.

In embodiments, the method includes overlapping a second one of the back flaps overlaps with a second one of the top flaps to form a fifth side joint on a second side of the interior space opposite the first side, overlapping the second one of the top flaps with a second one of the front flaps to form a sixth side joint on the second side of the interior space, overlapping the second one of the front flaps with a second one of the bottom flaps to form a seventh side joint on the second side of the interior space, and overlapping the second one of the bottom flaps with the second one of the back flaps to form an eighth side joint on the second side of the interior space. Respective flaps of at least one of the fifth, sixth, seventh, and/or eighth side joints can be adhered, and at least one of the fifth, sixth, seventh and/or eighth side joints can be left free of adhesive joining the respective flaps to facilitate conversion of the retail ready package for retail use.

In embodiments, adhering includes adhering respective flaps of the second, third, fourth, sixth, seventh, and eighth side joints, and wherein leaving free of adhesive includes leaving the first side joint and the fifth side joint free of adhesive. In embodiments, forming a plurality of panels to wrap at least partially around the interior space includes adhering an adhesive tab extending form an edge of the front panel opposite the top panel to the bottom panel to join the front panel to the bottom panel. In embodiments, forming a plurality of panels to wrap at least partially around the interior space includes adhering an adhesive tab extending from an edge of the top panel opposite the front panel to the back panel to join the top panel to the back panel.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 is a plan view of an exemplary embodiment of a blank for a retail ready package (RRP) constructed in accordance with the present disclosure, showing the panels and flaps;

FIG. 2 is a perspective view of the blank of FIG. 1, showing the blank being assembled into a package with an interior space;

FIG. 3 is a perspective view of the package of FIG. 2, showing the package in a packing/shipping orientation;

FIG. 4 is a perspective view of the package of FIG. 2, showing the package in a retail orientation prior to conversion for retail use;

FIG. 5 is an exploded perspective view of the package of FIG. 2, showing the package being converted for retail use;

FIG. 6 is a perspective view of the package of FIG. 5, showing the package converted for retail use with product on display;

FIG. 7 is a plan view of another exemplary embodiment of a blank for a retail ready package (RRP) constructed in accordance with the present disclosure, showing the panels and flaps;

FIG. 8 is a perspective view of the blank of FIG. 7, showing the blank being assembled into a package with an interior space;

FIG. 9 is a front elevation view of the package of FIG. 8, showing the package in a packing/shipping orientation;

FIG. 10 is a perspective view of the package of FIG. 8, showing the package in a retail orientation prior to conversion for retail use;

FIG. 11 is an exploded perspective view of the package of FIG. 8, showing the package being converted for retail use; and

FIG. 12 is a perspective view of the package of FIG. 8, showing the package converted for retail use with product on display.

### DETAILED DESCRIPTION OF THE PREFERRED EMBODIMENTS

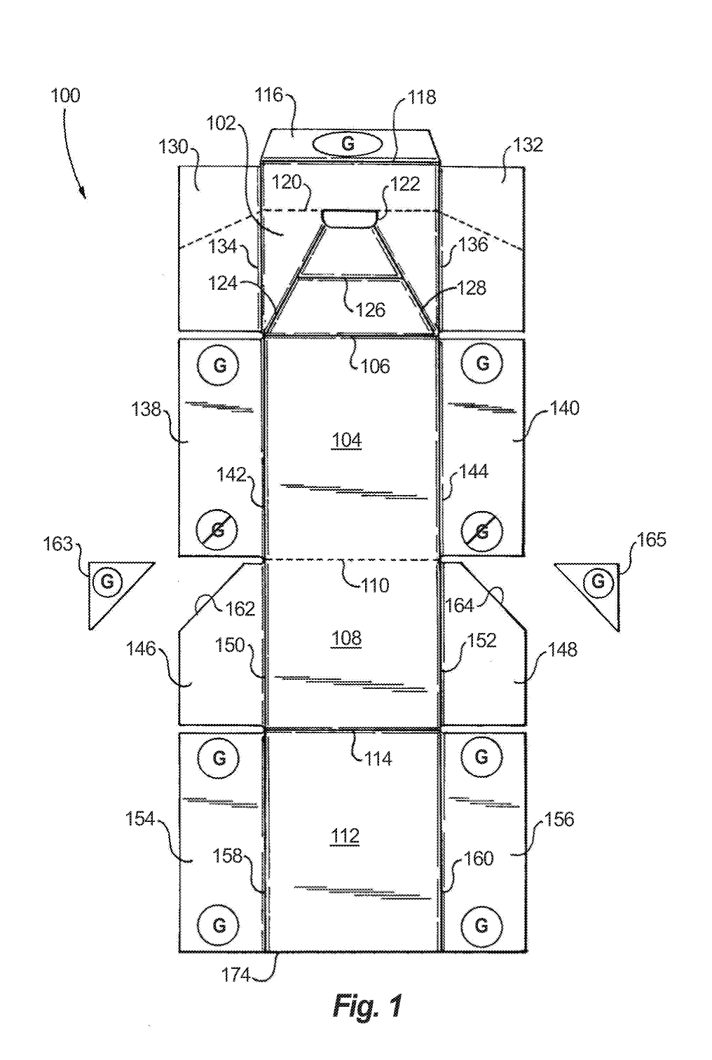

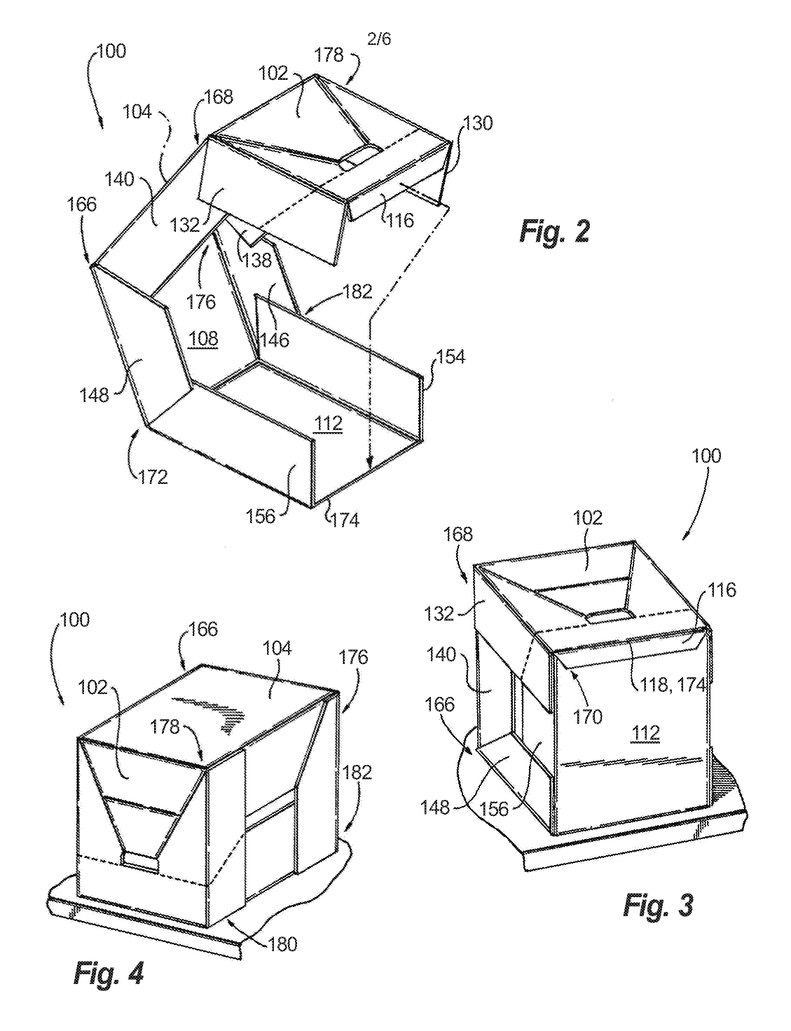

Reference will now be made to the drawings wherein like reference numerals identify similar structural features or aspects of the subject disclosure. For purposes of explanation and illustration, and not limitation, a partial view of an exemplary embodiment of a blank for forming a retail ready package (RRP) in accordance with the disclosure is shown in FIG. 1 and is designated generally by reference character 100. Other embodiments of blanks in accordance with the disclosure, or aspects thereof, are provided in FIGS. 2-12, as will be described. The systems and methods described herein can be used to provide RRPs that can be packed with product at a production plant, and then shipped directly to a retail location, where they can be converted for retail use without an intervening repackaging as in the conventional techniques.

A blank 100 for forming a retail ready package (RRP) includes a plurality of panels connected together at fold lines configured for extending at least partially around an interior space. The front panel 102 is connected to the top panel 104 at a fold line 106. The back panel 108 is connected to the top panel 104 at a fold line 110. The bottom panel 112 is connected to the back panel 108 at a fold line 114. A tear line extends along the fold line 110, which forms an edge where the top panel 104 and the back panel 104 meet. The tear lines disclosed herein can be formed by any suitable perforation or the like. An adhesive tab 116 extends form an edge 118 of the front panel 102 opposite the top panel 104. The adhesive tab 116 is configured to be adhered to the bottom panel 112 to join the front panel 102 to the bottom panel 112. A tear line 120 is defined across the front panel 102 for tearing the front panel 102 to convert the retail ready package as described below. A handle tear line 122 is included in the front panel 102, connecting with the tear line 120 to allow for gripping the front panel 102 to convert the retail ready package. The tear line 120 extends obliquely across each of the front flaps 130 and 132, i.e. obliquely downward as oriented in FIG. 1.

A plurality of fold lines 124, 126, and 128 are defined in the front panel 102 formed by any suitable process such as pressing or scoring. Fold line 124 extends from handle tear line 122 to a corner of front panel 102 along fold line 106. Fold line 128 extends from an opposite side of handle tear line 122 to the opposite corner of front panel 102 along fold line 106 from the fold line 124. Fold line 126 extends from fold line 124 to fold line 128 in a direction parallel to fold line 106 and at a point in panel 102 between handle tear line 122 and fold line 106. In this A-shaped configuration, fold lines 124, 126, and 128 facilitate activation of the handle tear line 122, i.e., to facilitate busting the tear lines 122 and 120.

A pair of opposed front flaps 130 and 132 is foldably connected along fold lines 134 and 136 to opposed edges of the front panel 102. A pair of opposed top flaps 138 and 140 is foldably connected along fold lines 142 and 144 to opposed edges of the top panel 104. A pair of opposed back flaps 146 and 148 is foldably connected along fold lines 150 and 152 to opposed edges of the back panel 108. A pair of opposed bottom flaps 154 and 156 is foldably connected along fold lines 158 and 160 to opposed edges of the bottom panel 112. A top portion 162 and 164 of each of the back flaps 146 and 148 is beveled, but could be radiused, i.e. to avoid hanging on adjacent packages and the like. The entire blank 100 including the plurality of panels 102, 104, 108, and 112 and flaps 130, 132, 138, 140, 146, 148, 154, and 156 as well as tab 116 can include any suitable material such as a corrugated paper board material.

FIG. 1 shows locations identified with a circled reference character “G” where adhesive can be applied so flaps 130, 132, 138, 140, 146, 148, 154 and 156 can be overlapped and glued or adhered together, and so tab 116 can be overlapped with bottom panel 112 and adhered together. The entire tab 116 can be covered with adhesive, and the tab 116 can ultimately be adhered inside or outside of bottom panel 112. FIG. 1 also shows locations identified with a bar-circled reference character “G” where flaps 138 and 140 are deliberately left free of adhesive so that when overlapped with flaps 146 and 148 there will be no adhesion at the joint where these flaps overlap.

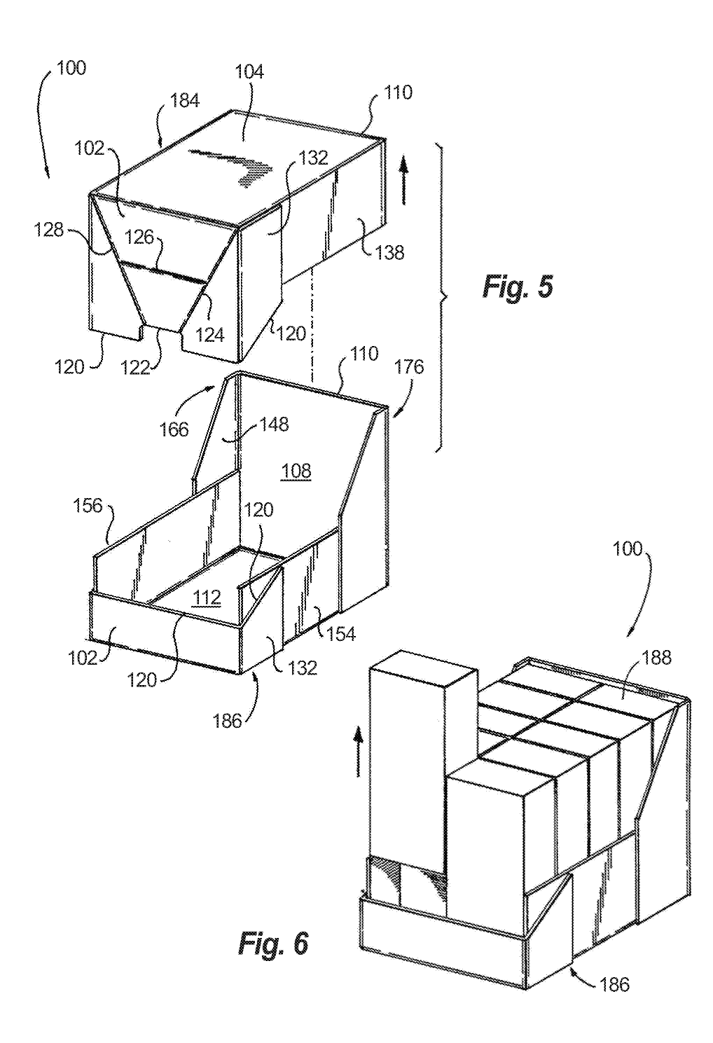

Optionally, flaps 146 and 148 can be rectangular with the bevel perforated to separate a triangular portion 163 and 165 from beveled portions 162 and 164 during conversion of the container, which is described below with reference to FIG. 5. In FIG. 1, triangular portions 163 and 165 are shown separated from the rest of blank 100, but it is to be understood that if included in the blank 100, they would be attached to beveled portions 162 and 164 along perforation lines so that each flap 146 and 148 defines a complete rectangle in blank 100. If perforated triangular portions 163 and 165 are included, they can be adhered to the corresponding portions of flaps 138 and 140 when the container is formed out of blank 100. The beveled perforations between the triangular portions 163/165 and flaps 146 and 148 along the edges of beveled portions 162 and 164 can then be busted to separate the flaps 146 and 148 from flaps 138 and 140. In this case, the beveled portions 162 and 164 should not be adhered to flaps 138 and 140, to avoid interfering with the conversion process described below with reference to FIG. 5.

With reference now to FIG. 2, forming a blank 100 as shown in FIG. 1 into a case wrapper type RRP is explained. This could also be produced on a traditional case erector or mandrel wrap style machine. On one side of the interior space of the ultimate package, i.e., the side with flaps in the foreground in FIG. 2, back flap 148 overlaps with the outside of the top flap 140 to form a first side joint 166. The top flap 140 overlaps with the inside of the front flap 132 to form a second side joint 168. The front flap 132 overlaps with the outside of the bottom flap 156, as shown in FIG. 3, to form a third side joint 170. The bottom flap 156 overlaps with the inside of the back flap 148 to form a fourth side joint 172. As indicated by the broken line in FIG. 2, tab 116 is overlapped with the inside or outside of bottom panel 112 so that fold line 118 is along edge 174 of the bottom panel 112 in the fully formed package as shown in FIG. 3. Each of the side joints 168, 170, and 172 includes adhesive joining the respective flaps, and joint 166 is deliberately kept free of adhesive joining the respective flaps 140 and 148 to facilitate conversion of the retail ready package for retail use.

With continued reference to FIG. 2, on a second side of the interior space opposite the first side of the interior space of the ultimate package, i.e., on the side in the background in FIG. 2, flaps 154, 146, 138, and 130 overlap in a similar pattern as that described above. Back flap 146 overlaps with the outside of the top flap 138 to form a fifth side joint 176. Top flap 138 overlaps with the inside of the front flap 130 to form a sixth side joint 178. The front flap 130 overlaps with the outside of the bottom flap 154 to form a seventh side joint 180 (shown in FIG. 4). The bottom flap 154 overlaps with the inside of the back flap 146 to form an eighth side joint 182. The fifth side joint 176 is kept free of adhesive, and the sixth, seventh, and eighth side joints 178, 180, and 182 each include adhesive.

With reference now to FIG. 3, the blank 100 is shown fully formed or assembled into retail ready package with an interior space for containing product within the panels and flaps. In FIG. 3, the package is shown with front panel 102 actually on top. It is contemplated that the package can be packed and shipped in this orientation, e.g., for flash frozen food products that must be frozen lying flat but are to be sold standing upright. Later, in the retail setting, the package can be flipped down to lie on bottom panel 112 with front panel 102 facing forward as shown in FIG. 4.

With reference to FIG. 5, the package formed from blank 100 can be separated into an upper component 184, which can be discarded/recycled, and a lower component 186 which displays product 188 for retail as shown in FIG. 6. This conversion includes activating the tear line 120 and handle tear line 122, as well as the tear line along fold line 110. Since the flaps in side joints 166 and 176 are not adhered, the upper component 184 can simply be lifted away once the tear lines 120, 122, and the tear line along fold line 110 are torn or busted. Fold lines 124, 126, and 128 are strictly optional, however can be advantageous in facilitating a user busting handle tear line 122 to initiate the conversion. The adhesion of flaps in the other side joints keeps the upper and lower components 184 and 186 rigidly formed and intact after the conversion. As indicated by the broken lines in FIG. 6, customers can access and remove product directly from lower component 186 in the retail setting. It should be noted that in order to facilitate the separation shown in FIG. 5, the portions of the bottom flaps 154 and 156 that ultimately end up above the oblique portions of tear line 120 should be kept free of adhesive.

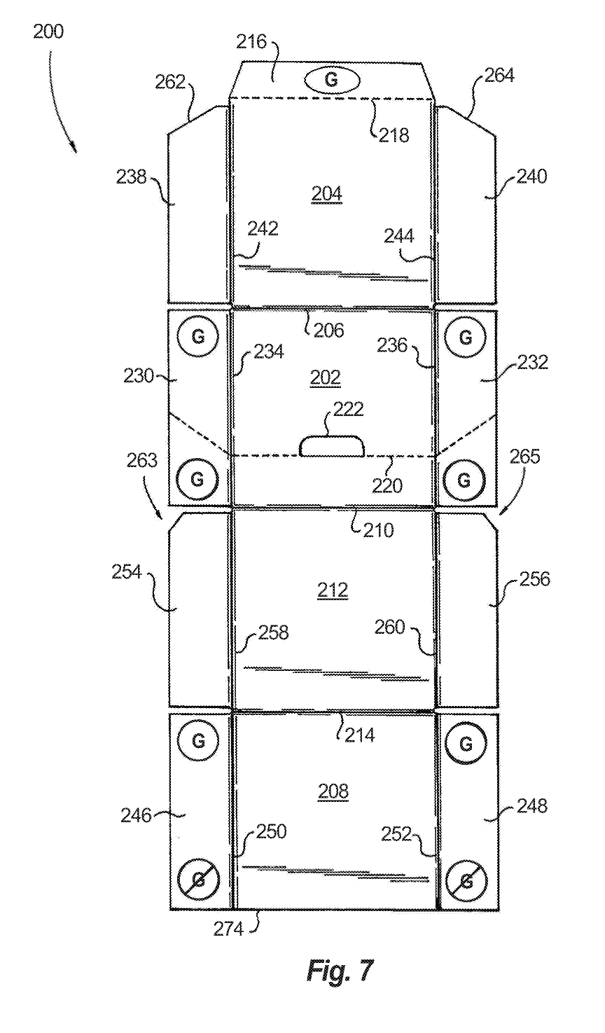

With reference now to FIG. 7, another exemplary embedment of a blank 200 for forming a retail ready package (RRP) is described. Blank 200 includes a plurality of panels connected together at fold lines configured for extending at least partially around an interior space, much as described above with reference to blank 100. The front panel 202 is connected to the top panel 204 at a fold line 206. The bottom panel 212 is connected to the front panel 202 at a fold line 210. The bottom panel 212 is connected to the back panel 208 at a fold line 214. An adhesive tab 216 extends form a fold line 218 of the top panel 204 opposite the front panel 202. A tear line extends along the fold line 218, which when the package is fully formed forms an edge between the top panel 204 and the back panel 208. The adhesive tab 216 is configured to be adhered to the back panel 208 to join the top panel 204 to the back panel 208. A tear line 220 is defined across the front panel 202 for tearing the front panel 202 to convert the retail ready package. A handle tear line 222 is included in the front panel 202, connecting with the tear line 220 to allow for gripping the front panel 220 to convert the retail ready package. The tear line 220 extends obliquely across each of the front flaps 230 and 232, i.e. obliquely downward as oriented in FIG. 1.

The pair of opposed front flaps 230 and 232 is foldably connected along fold lines 234 and 236 to opposed edges of the front panel 202. A pair of opposed top flaps 238 and 240 is foldably connected along fold lines 242 and 244 to opposed edges of the top panel 204. A pair of opposed back flaps 246 and 248 is foldably connected along fold lines 250 and 252 to opposed edges of the back panel 208. A pair of opposed bottom flaps 254 and 256 is foldably connected along fold lines 258 and 260 to opposed edges of the bottom panel 212. A back portion 262 and 264 of each of the top flaps 238 and 240 is beveled, but could be radiused as described above. A front portion 263 and 265 of the bottom flaps 254 and 256 are also beveled, to avoid interference with activation of the oblique portions of tear line 220. The entire blank 200 can include any suitable material such as a corrugated paper board material. The beveled portions could be radiused or the like, and prevent hanging up on other packaging or the like due to the fact that these portions are not glued down or adhered.

FIG. 7 shows locations identified with a circled reference character “G” where adhesive can be applied so flaps 230, 232, 238, 240, 246, 248, 254 and 256 can be overlapped and glued or adhered together, and so tab 216 can be overlapped with back panel 208 and adhered together. FIG. 5 also shows locations identified with a bar-circled reference character “G” where flaps 246 and 248 are deliberately left free of adhesive so that when overlapped with flaps 238 and 240 there will be no adhesion at the joint where these flaps overlap.

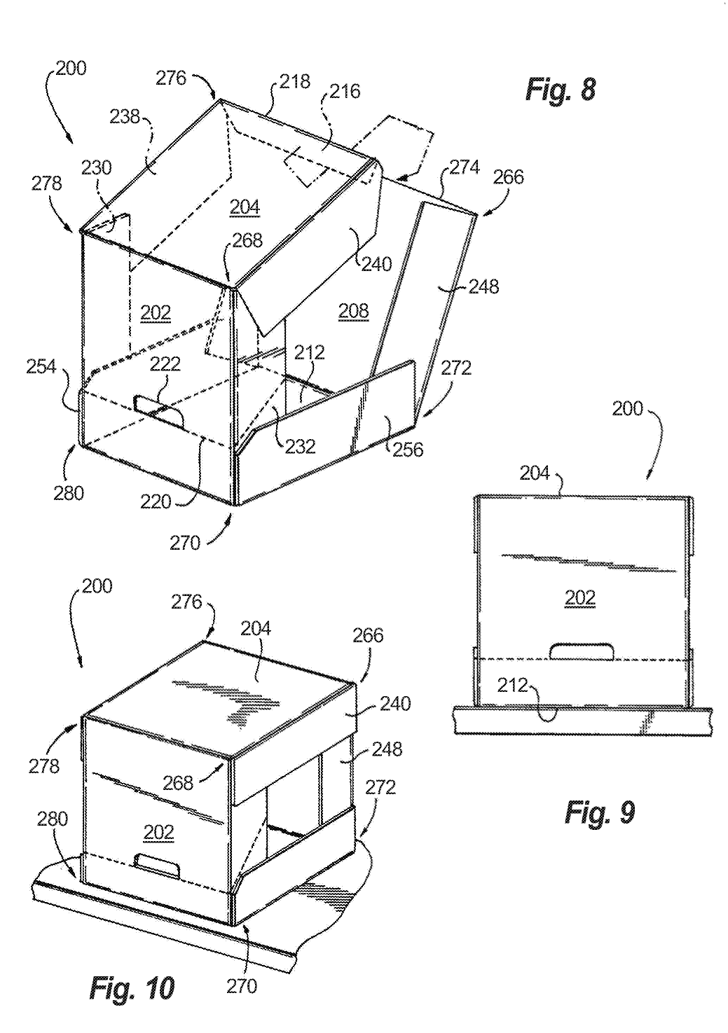

With reference now to FIG. 8, forming a blank 200 as shown in FIG. 7 into a case wrapper type retail ready package (RRP) is explained. On one side of the interior space of the ultimate package, i.e., the side with flaps in the foreground in FIG. 8, back flap 248 overlaps with the inside of the top flap 240 to form a first side joint 266, as shown in FIG. 10. The top flap 240 overlaps with the outside of the front flap 232 to form a second side joint 268. The front flap 232 overlaps with the inside of the bottom flap 256 to form a third side joint 270. The bottom flap 256 overlaps with the outside of the back flap 248 to form a fourth side joint 272. As indicated by the broken line in FIG. 8, tab 216 is overlapped with the inside of back panel 208 so that fold line 218 is along edge 274 of the back panel 208 in the fully formed package as shown in FIGS. 9-10. Each of the side joints 268, 270, and 272 includes adhesive joining the respective flaps, and joint 266 is deliberately kept free of adhesive joining the respective flaps 240 and 248 to facilitate conversion of the retail ready package for retail use.

With continued reference to FIG. 8 and with reference to FIG. 7, on the second side of the interior space opposite the first side of the ultimate package, i.e., on the side in the background in FIG. 8, flaps 254, 246, 238, and 230 overlap in a similar pattern as that described above with respect to the first side flaps 248, 256, 232, and 240. Back flap 246 overlaps with the inside of the top flap 238 to form a fifth side joint 276. Top flap 238 overlaps with the outside of the front flap 230 to form a sixth side joint 278. The front flap 230 overlaps with the inside of the bottom flap 254 to form a seventh side joint 280. The bottom flap 254 overlaps with the outside of the back flap 246 to form an eighth side joint 282. The fifth side joint 276 is kept free of adhesive, and the sixth, seventh, and eighth side joints 278, 280, and 282 each include adhesive.

With reference now to FIG. 9, the blank 200 is shown fully formed or assembled into retail ready package with an interior space for containing product within the panels and flaps. In FIG. 9, the package is shown with front panel 202 facing forward with top panel 204 on top. It is contemplated that the package can be packed and shipped in this orientation, and later, in the retail setting, the package can be kept in the same orientation as shown in FIG. 10.

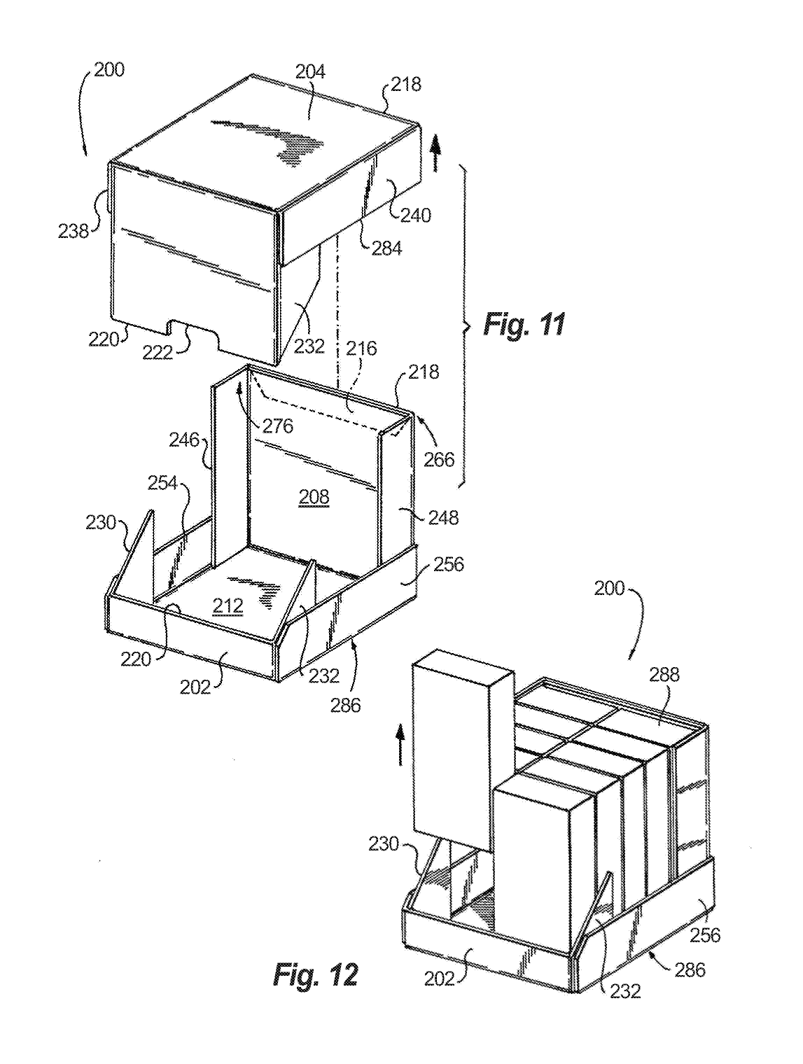

With reference now to FIG. 11, the package formed from blank 200 can be separated into an upper component 284, which can be discarded/recycled, and a lower component 286 which displays product 288 for retail as shown in FIG. 12. This conversion includes activating the tear line 220 and handle tear line 222, as well as the tear line along fold line 218. Since the flaps in side joints 266 and 276 are not adhered, the upper component 284 can simply be lifted away once the tear lines 220, 222, and the tear lie along the fold line 218 are torn. The adhesion of flaps in the other side joints keeps the upper and lower components 284 and 286 rigidly formed and intact after the conversion. As indicated by the broken lines in FIG. 12, customers can access and remove product directly from lower component 286 in the retail setting.

The methods and systems of the present disclosure, as described above and shown in the drawings, provide for RRPs with superior properties including eliminating the need for a separate RRP packaging process after product has been packaged at a production site. While the apparatus and methods of the subject disclosure have been shown and described with reference to preferred embodiments, those skilled in the art will readily appreciate that changes and/or modifications may be made thereto without departing from the scope of the subject disclosure.

What is claimed is:

1. A blank for forming a retail ready package (RRP) comprising:
a plurality of panels connected together at fold lines configured for extending at least partially around an interior space, including a front panel, a top panel, a back panel and a bottom panel;
a pair of opposed back flaps foldably connected to opposed edges of the back panel;
a pair of opposed bottom flaps foldably connected to opposed edges of the bottom panel;
a pair of opposed front flaps foldably connected to opposed edges of the front panel; and
a pair of opposed top flaps foldably connected to opposed edges of the top panel, wherein a first one of the back flaps is configured to overlap with a first one of the top flaps to form a first side joint, the first one of the top flaps is configured to overlap with a first one of the front flaps to form a second side joint, the first one of the front flaps is configured to overlap with a first one of the bottom flaps to form a third side joint, and the first one of the bottom flaps is configured to overlap with the first one of the back flaps to form a fourth side joint, wherein at least one of the side joints includes adhesive joining the respective flaps, and wherein at least one of the side joints is free of adhesive joining the respective flaps to facilitate conversion of the retail ready package for retail use.

2. The blank as recited in claim 1, wherein a tear line is defined across the front panel for tearing the front panel to convert the retail ready package.

3. The blank as recited in claim 2, wherein a handle tear line is included in the front panel, connecting with the tear line defined across the front panel for gripping the front panel to convert the retail ready package.

4. The blank as recited in claim 3, wherein the tear line extends obliquely across each of the front flaps.

5. The blank as recited in claim 1, wherein the front panel is connected to the top panel at a fold line, wherein the back panel is connected to the top panel at a fold line, and wherein the bottom panel is connected to the back panel at a fold line, wherein a tear line extends along an edge where the top panel and back panel meet.

6. The blank as recited in claim 5, further comprising an adhesive tab extending form an edge of the front panel opposite the top panel, wherein the adhesive tab is configured to be adhered to the bottom panel to join the front panel to the bottom panel.

7. The blank as recited in claim 5, wherein a tear line is defined across the front panel for tearing the front panel to convert the retail ready package, wherein a handle tear line is included in the front panel, connecting with the tear line defined across the front panel for gripping the front panel to convert the retail ready package, and wherein an plurality of fold lines are defined in the front panel for facilitating activation of the handle tear line.

8. The blank as recited in claim 1, wherein the top panel is connected to the front panel at a fold line, the bottom panel is connected to the front panel at a fold line, and the back panel is connected to the bottom panel at a fold line.

9. The blank as recited in claim 8, further comprising an adhesive tab extending from an edge of the top panel opposite the front panel, wherein the adhesive tab is configured to be adhered to the back panel to join the top panel to the back panel.

10. The blank as recited in claim 9, wherein the adhesive tab connects to the top panel along a tear line for facilitating conversion of the retail ready package for retail use.

11. The blank as recited in claim 1, wherein at least one of:
a back portion of each of the top flaps is beveled;
a top portion of each of the back flaps is beveled; and/or
a front portion of each of the bottom flaps is beveled.

12. The blank as recited in claim 1, wherein the plurality of panels includes a corrugated paper board material.

13. A retail ready package comprising:
a plurality of panels extending at least partially around an interior space, including a front panel connected to a top panel, a back panel connected to the top panel, and a bottom panel connected to the back panel and to the front panel;
a pair of opposed back flaps foldably connected to opposed edges of the back panel;
a pair of opposed bottom flaps foldably connected to opposed edges of the bottom panel;
a pair of opposed front flaps foldably connected to opposed edges of the front panel; and
a pair of opposed top flaps foldably connected to opposed edges of the top panel,
wherein on a first side of the interior space, a first one of the back flaps overlaps with a first one of the top flaps to form a first side joint, the first one of the top flaps overlaps with a first one of the front flaps to form a second side joint, the first one of the front flaps overlaps with a first one of the bottom flaps to form a third side joint, and the first one of the bottom flaps overlaps with the first one of the back flaps to form a fourth side joint, wherein at least one of the side joints includes adhesive joining the respective flaps, and wherein at least one of the side joints is free of adhesive joining the respective flaps to facilitate conversion of the retail ready package for retail use.

14. The retail ready package as recited in claim 13, wherein on a second side of the interior space opposite the first side, a second one of the back flaps overlaps with a second one of the top flaps to form a fifth side joint, the second one of the top flaps overlaps with a second one of the front flaps to form a sixth side joint, the second one of the front flaps overlaps with a second one of the bottom flaps to form a seventh side joint, and the second one of the bottom flaps overlaps with the second one of the back flaps to form an eighth side joint, wherein at least one of the fifth, sixth, seventh, and/or eighth side joints includes adhesive joining the respective flaps, and wherein at least one of the fifth, sixth, seventh and/or eighth side joints is free of adhesive joining the respective flaps to facilitate conversion of the retail ready package for retail use.

15. The retail ready package as recited in claim 14, wherein the first side joint and the fifth side joint are free of adhesive, and wherein the second, third, fourth, sixth, seventh, and eighth side joints each include adhesive.

16. A method of assembling a retail ready package (RRP) comprising:
forming a plurality of panels to wrap at least partially around an interior space, wherein the panels include a front panel connected to a top panel, a back panel connected to the top panel, and a bottom panel connected to the back panel and to the front panel, with a pair of opposed back flaps foldably connected to opposed edges of the back panel, a pair of opposed bottom flaps foldably connected to opposed edges of the bottom panel, a pair of opposed front flaps foldably connected to opposed edges of the front panel, and a pair of opposed top flaps foldably connected to opposed edges of the top panel;
overlapping a first one of the back flaps with a first one of the top flaps to form a first side joint on a first side of the interior space;
overlapping the first one of the top flaps with a first one of the front flaps to form a second side joint on the first side of the interior space;
overlapping the first one of the front flaps with a first one of the bottom flaps to form a third side joint on the first side of the interior space;
overlapping the first one of the bottom flaps overlaps with the first one of the back flaps to form a fourth side joint on the first side of the interior space;
adhering respective flaps of at least one of the side joints; and
leaving at least one of the side joints free of adhesive joining the respective flaps to facilitate conversion of the retail ready package for retail use.

17. The method as recited in claim 16, further comprising:
overlapping a second one of the back flaps overlaps with a second one of the top flaps to form a fifth side joint on a second side of the interior space opposite the first side;
overlapping the second one of the top flaps with a second one of the front flaps to form a sixth side joint on the second side of the interior space;
overlapping the second one of the front flaps with a second one of the bottom flaps to form a seventh side joint on the second side of the interior space;
overlapping the second one of the bottom flaps with the second one of the back flaps to form an eighth side joint on the second side of the interior space;
adhering respective flaps of at least one of the fifth, sixth, seventh, and/or eighth side joints; and
leaving at least one of the fifth, sixth, seventh and/or eighth side joints free of adhesive joining the respective flaps to facilitate conversion of the retail ready package for retail use.

18. The method as recited in claim 17, wherein adhering includes adhering respective flaps of the second, third, fourth, sixth, seventh, and eighth side joints, and wherein leaving free of adhesive includes leaving the first side joint and the fifth side joint free of adhesive.

19. The method as recited in claim 16, wherein forming a plurality of panels to wrap at least partially around the interior space includes adhering an adhesive tab extending form an edge of the front panel opposite the top panel to the bottom panel to join the front panel to the bottom panel.

20. The method as recited in claim 16, forming a plurality of panels to wrap at least partially around the interior space includes adhering an adhesive tab extending from an edge of the top panel opposite the front panel to the back panel to join the top panel to the back panel.
